(19) United States
(12) Patent Application Publication
(10) Pub. No.: US 2007/0064690 A1
(43) Pub. Date: Mar. 22, 2007

(54) Method and system for routing protocol outbound route control

(75) Inventor: Ramesh Karpagavinayagam, North Chemelsford, MA (US)

Correspondence Address: Alan M. Weisberg;Christopher & Weisberg, P.A., Suite 2040, 200 East Las Olas Boulevard, Fort Lauderdale, FL, 33301, US

(73) Assignee: Nortel Networks Limited

(21) Appl. No.: 11/233,338

(22) Filed: Sep. 22, 2005

(51) Int. Cl. H04L 12/28

(52) U.S. Cl. 370/389; 370/401

(57) ABSTRACT

A method and apparatus in a system for exchanging routing information with a peer router in another system, in which the apparatus and peer router are in data communication. The apparatus has a network interface for receiving and transmitting the routing information and a central processing unit in operative communication with the network interface. The central processing unit operates to determine a resource utilization level of the apparatus and establish a peering relationship with the peer router based on the resource utilization level.

### CROSS-REFERENCE TO RELATED APPLICATIONS

n/a

### STATEMENT REGARDING FEDERALLY SPONSORED RESEARCH OR DEVELOPMENT

n/a

### BACKGROUND OF THE INVENTION

1. Statement of the Technical Field

The present invention relates to the field of networking communications and more particularly to a method and system for allowing efficient sharing of network routing information through outbound route control using a routing protocol such as the border gateway protocol (BGP).

2. Description of the Related Art

While many communication networks, such as the Internet, are perceived by end users as one network, these large networks are often made up from many interconnected smaller networks. For example, different service providers, each having their own customers often enter into arrangements, known as peering agreements, in which the different providers interconnect their networks and agree to share routing information and agree to transport each other's network traffic, e.g., data packets.

Individual service providers typically implement a complex packet routing scheme, such as the Open Shortest Path First (“OSPF”) routing protocol, to share routing information internally among nodes in the service provider's own network. For ease of explanation, a service provider's network that implements its own internal routing scheme is referred to herein as an autonomous system. While robust, these “internal” routing protocols do not scale to the size necessary to accommodate large, multi-service provider networks and do not offer the flexibility needed for each operator of an autonomous system to control its own routing environment.

To allow such control, external gateway protocols such as BGP are used by service providers to share routing information among their peer autonomous systems. This allows service providers the ability to control what routing information, such as which networks are available via that service provider, is provided to interconnected peer networks and the ability to filter out routes to networks that are provided to it by the interconnected peer networks.

As can be imagined, the size of networks such as the Internet requires large amounts of route information be shared among peers. Network processing nodes such as routers are little more than special purpose computing platforms designed to quickly process inbound data packets and route the data packets to the next node (or destination device) in the network. As such, routers suffer from the same limitations as general purpose computers such as desktop personal computers. These limitations include a finite amount of central processing unit and/or network interface unit processing power and finite amounts of memory and buffer space. Therefore, there is a need by service providers to be able to control the volume of routing information transmitted to or received from peer autonomous systems. This control is referred to as route throttling.

Current BGP implementations allow two kinds of route throttling, namely policy based route control and a negotiated arrangement to limit outbound routes provided to peer autonomous systems. Neither of these route throttling mechanisms solve the above-described problem. With policy based route control, the flow of data is enforced using policy based distribution of routing information. This enforcement allows control over who can and who can not use specific network resources. Examples of such policies include routing peer authentication based on the source address of the routing peer, verification of the autonomous system, such as be verification of the autonomous system number, verification of the transmission control protocol/internet protocol (“TCP/IP”) network numbers which are advertised via the routing peer and through the control of metrics using a routing policy database for the announced TCP/IP network numbers to allow for primary and alternate paths to the autonomous system.

These route throttling methods do not guarantee the reliable exchange of routing information or even that routing information received on a resource loaded system such as a router, switch, etc., will be processed during the occurrence of route flaps. Route flaps, a regular occurrence in the Internet, is the rapid injection and withdrawal of routes to/from routing tables. Route flaps cause a heavy processing load on routers thus impacting overall routing stability. Route flaps can be caused by can be caused by the disconnection and reconnection of network links or physical interfaces, by misconfigured or mismanaged routers, or any other condition which necessitates the rapid removal and reinsertion of routes in a routing table.

Similarly, negotiated arrangement to limit outbound routes provided to peer autonomous systems puts the burden on the transmitting router and corresponding service provider, to operate properly and honor the negotiated arrangement. As such, route reliability is not guaranteed and situations which consume all of the resources of the receiving router can still arise.

### SUMMARY OF THE INVENTION

The invention describes an apparatus and method which advantageously provides outbound route control for routing updates such as BGP routing updates.

According to one aspect, the present invention provides an apparatus in a system for exchanging routing information with a peer router in another system, in which the apparatus and peer router are in data communication. The apparatus has a network interface for receiving and transmitting the routing information and a central processing unit in operative communication with the network interface. The central processing unit operates to determine a resource utilization level of the apparatus and establish a peering relationship with the peer router based on the resource utilization level.

According to another aspect, the present invention provides a method for an apparatus in a routing system to exchange routing information with a peer router in another system, in which a resource utilization level of the apparatus is determined. A peering relationship is established with the peer router based on the resource utilization level.

According to yet another aspect, the present invention provides a storage medium storing a computer program which when executed by a processing unit performs a method for an apparatus in a routing system to exchange routing information with a peer router in another system, in which a resource utilization level of the apparatus is determined. A peering relationship is established with the peer router based on the resource utilization level.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of a system constructed in accordance with the principles of the present invention;

FIG. 2 is a flow chart of overall process of the present invention;

FIG. 3 is a flow chart of a new peer processing process of the present invention;

FIG. 4 is a flow chart of a deferred peer processing process of the present invention; and

FIG. 5 is a flow chart of an unsynchronized peer processing process of the present invention.

### DETAILED DESCRIPTION OF THE PREFERRED EMBODIMENTS

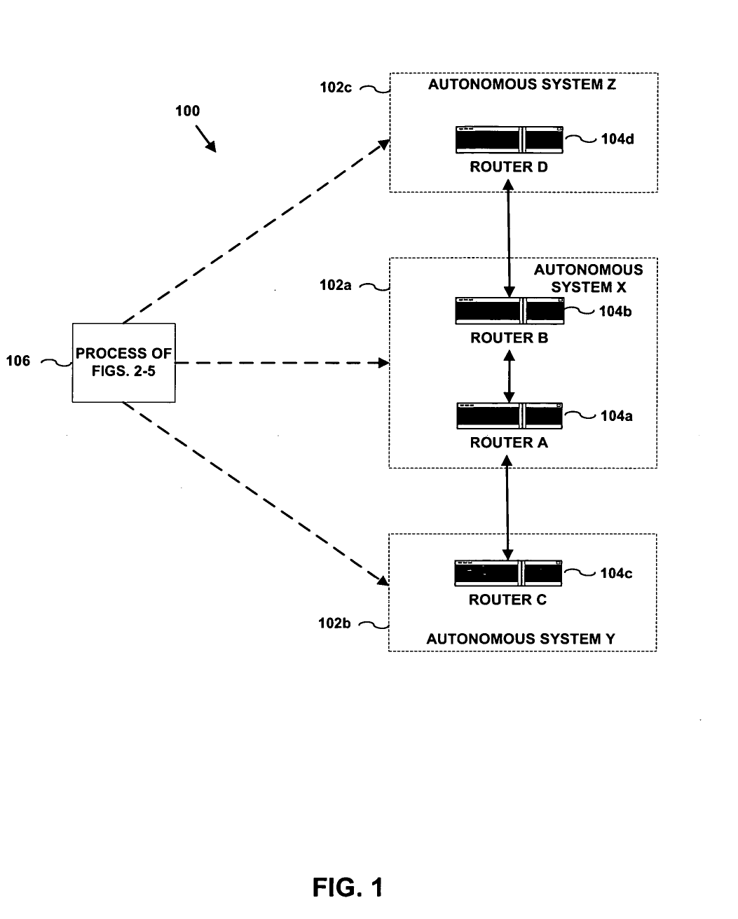

Referring now to the drawing figures in which like reference designators refer to like elements, there is shown in FIG. 1, a system constructed in accordance with the principles of the present invention and designated generally as “100”. System 100 can include one or more autonomous systems. For example, as shown in FIG. 1, three autonomous systems namely autonomous system X 102a, Autonomous system Y 102b, and autonomous system, Z 102c (autonomous system 102a, 102b, 102c are referred to collectively, herein as autonomous system 102) are shown in which autonomous system X 102a is interconnected with autonomous system Y 102b and autonomous system Z 102c. Accordingly, routes to networks originating within autonomous systems X 102a can be transmitted to, and shared with autonomous system Y 102b and autonomous system Z 102c. Similarly, routes to networks available via autonomous system Y 102b can be transmitted to autonomous system X 102a, which, depending on the desires of the network designers, can intern be shared with autonomous system Z 102c.

Traffic and routing information is transported using routers. For example, as is shown in FIG. 1, autonomous system X includes router A 104a and router B 104b, while autonomous systems Y includes router C 104c and autonomous systems Z 102c includes router D 104d (routers 104a-d are referred to collectively herein as routers 104). Of note, although the term “router” is used herein to refer to the network element used to transport data and/or routing information within and between autonomous systems, it is readily understood by one of ordinary skill in the art that the present invention is not limited to such. Accordingly, the term “router” as used herein, can refer to any switching network element, such as a switch, router or any other computing device, such that the present invention is not limited to the use of routers in the traditional sense. Put another way, the term “router” is used merely for convenience herein and is not intended to limit the present invention to only traditional routing platforms.

Routers 104 include suitable hardware and software to enable them to perform the functions described herein with respect to the present invention. For example, routers 104 include a central processing unit, volatile and non-volatile memory and storage devices, network interfaces and processors as well as other I/O interfaces to enable configuration. It is contemplated that a service provider can maintain responsibility for the operation of one or more of the autonomous systems 1 02a-c. However, more typically a service provider will provide and support a single autonomous system such as autonomous system X 102a which will transmit and receive routing information to and from the other autonomous systems to which it is interconnected, for example, autonomous system Y 102b and/or autonomous system Z 102c.

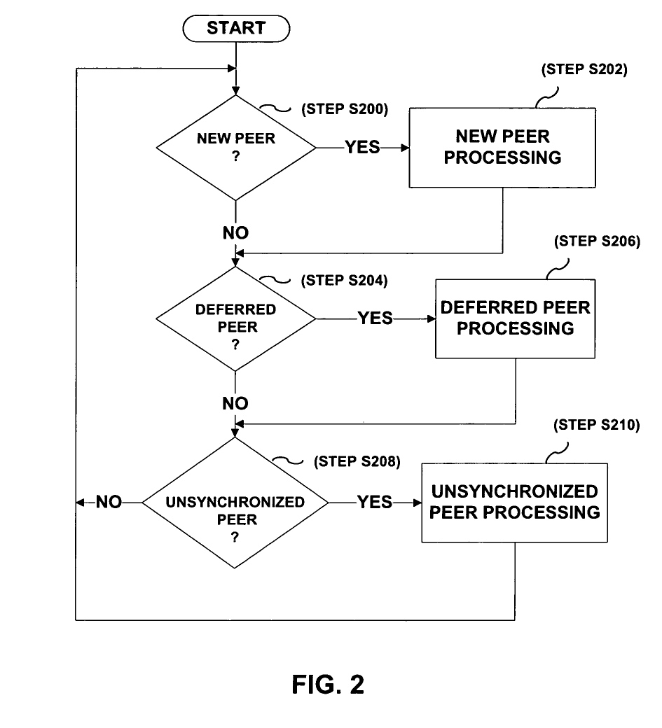

The present invention as described below in detail, advantageously allows a router 104 within an autonomous system 102, to automatically control how routing updates are received and transmitted to/from peer autonomous systems based on the loading of the routers in the autonomous systems 102. In addition, as is discussed below, the present invention advantageously allows the propagation of routing information to be throttled when loading conditions on a router exceed a predetermined threshold. These processes, shown as block 106 in FIG. 1 are described below in detail with reference to FIGS. 2-5.

The overall process of the present invention is described with reference to FIG. 2. Initially it is noted that there are three general states for dealing with and supporting the exchange of routing information with autonomous system peer routers. These states include functions relating to the handling of a new peer, functions relating to the handling of a “deferred” peer and functions relating to the support of an “unsynchronized” peer. The terms “deferred peer” and “unsynchronized peer” are defined and explained below.

In accordance with the process flow of the present invention, a determination is made by a router 104 as to whether there are any new peers attempting to exchange routing information with an autonomous system 102 (step S200). If a new peer is found, new peer processing (step S202) is performed. For ease of explanation herein, referring to FIG. 1, assume that autonomous system X 102a is the system of interest and router 104a detects the presence of a new peer router C 104c. In that case, new peer processing (step S202) would be performed by router A 104a with respect to the newly learned peer router C 104c in autonomous system Y 102b.

If there are no new peers to service, router 104 determines whether there are any “deferred” peers to service (step S204). The deferred peers are processed (step S206). In general, a deferred peer is a peer that has been detected/established, but the routes received from that peer have not been accepted due to resource limitations on the receiving peer. For example, if router C 104c has been established as a new, but deferred peer with respect to router A 104a, router A 104a would attempt to process router C 104c as part of step S206.

If there are no deferred peers or no deferred peers left to be serviced, router 104 then determines whether there are any unsynchronized peers (step S208). Unsynchronized peers are processed (step S210) and the process reverts to the beginning. As is explained below in greater detail, an unsynchronized peer is generally a peer that has had certain routes processed into routing table, for example, route deletions, but whose routing information has not been completely processed into the routing table, for example, route additions. For example referring to FIG. 1, router B 104b would, in connection with step S210, attempt to process routing information received from router D 104d in an effort to synchronize the routing information between router B 104b and router D 104d.

Of note, although FIG. 2 shows the general processing order as new peers, than deferred peers, than unsynchronized peer, the present invention is not limited to such. It is contemplated that the functions shown in steps S202, S206, and S210 can be performed in any order. As such, the order shown in FIG. 2 is merely to aid convenience of explanation and understanding of the present invention.

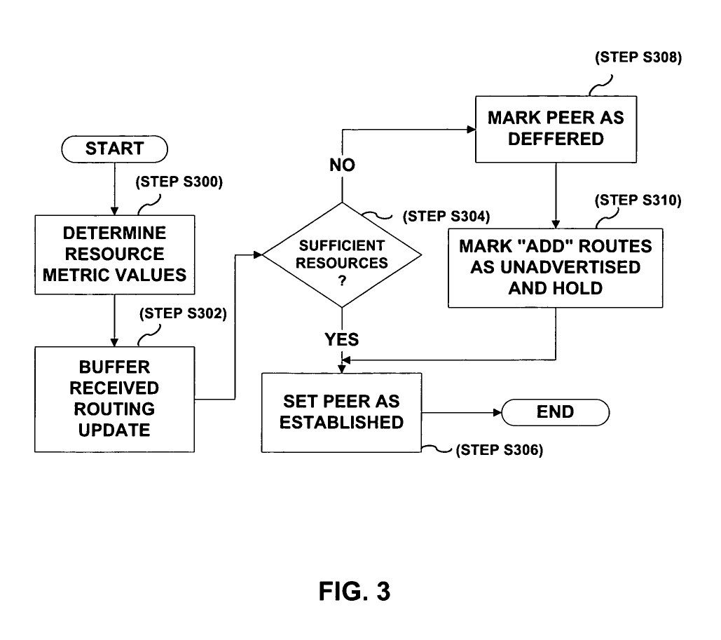

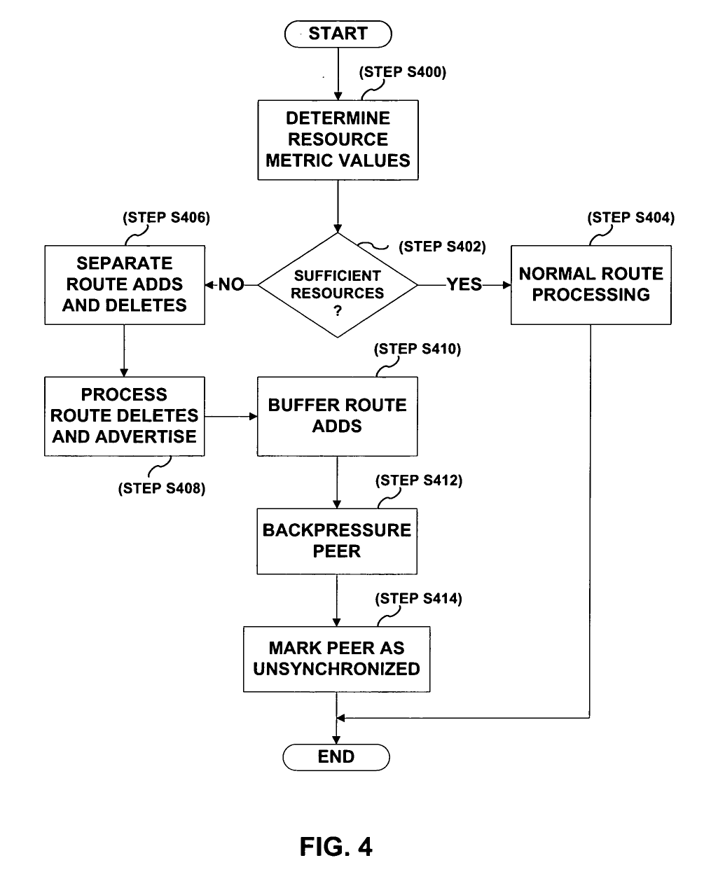

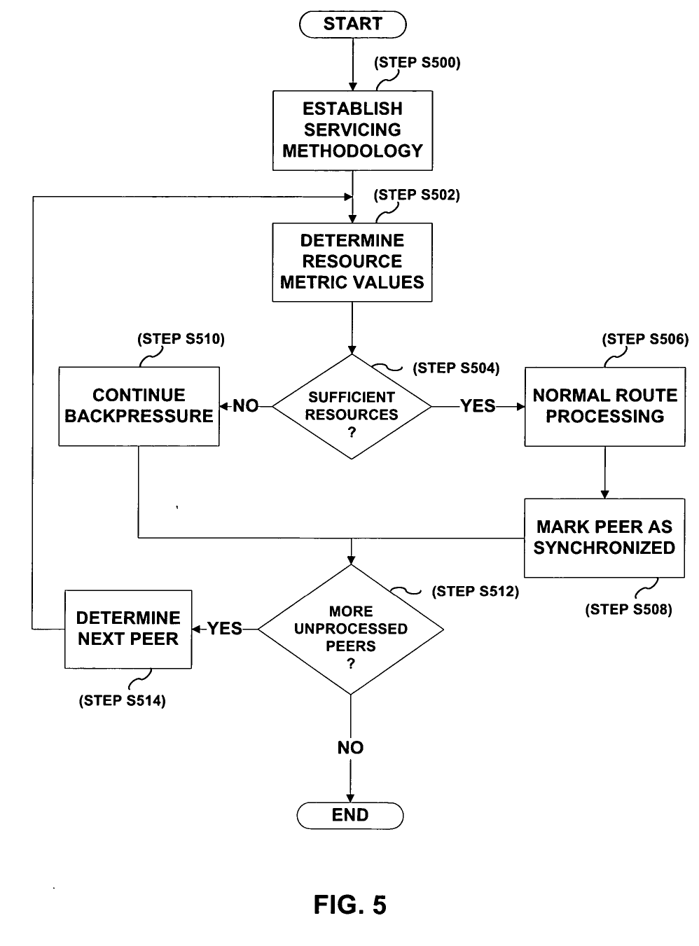

New peer processing, shown as step S202 in FIG. 2, is explained in detail with reference to FIG. 3. To aid explanation and understanding of the present invention, it is assumed that the router doing the peer processing, is router A 104a in FIG. 1, and the router that is being brought up as the new, deferred, and/or unsynchronized peer is router C 104c. This will also be the case for the explanations set forth below with respect to FIGS. 4 and 5.

Initially, a determination is made as to the loading threshold that a router can withstand in order to adequately accept and process routing updates from peers. Such resource metric values can include but are not limited to CPU utilization, buffer utilization, volatile and/or non-volatile memory availability and network interface bandwidth utilization, and the like. Such resource metric threshold values can be set to a predetermined default based on the general capacities of router 104, or can be customized by a system operator. The resource metric threshold as well as a suitable algorithm used to evaluate the various metrics to determine resource sufficiency, is stored in router 104.

When a new peer is detected, router A 104a determines the values for the resource metrics to be used to determine the router resource availability (step S300). Router A 104a also buffers the received update from the new peer (step S302), for example, router C 104c. If, based on the resource metric values determined in step S300 as compared with the predetermined threshold for peer establishment, sufficient resources exist (step S304), router C 104c is set as an established peer and the routing update, for example, route additions and deletions received from router C are processed, routes from autonomous systems X 102a are sent by router A 104a to that router C 104c, and router C, 104c is set as an established peer (step S306).

If however, it is determined that sufficient resources do not exist, (step S304), router C 104c is marked as a deferred peer (step S308) within a peer table in router A 104a. In this case, routes received from router C 104c are marked as unadvertised and held by router A 104a (step S310). In other words, the route additions are buffered but are not processed into the actual routing table, for example the BGP routing table within router A 104a. This arrangement allows a new peer to be recognized and routes received while still saving the resources required to actually process and insert route additions into the BGP routing table. In addition, although not shown in FIG. 3, routing information from router A 104a is not transmitted to router C 104c. Accordingly, router A 104a knows of the existence of new peer router C 104c but defers more substantial processing until adequate resources are available in router A 104a to process the complete routing update. This arrangement advantageously avoids route flaps overloading in an already overloaded router without the burden of processing routes received from a new peer and transmitting routes to the new peer.

The processing of deferred peers shown as step S206 in FIG. 2 is explained with reference to FIG. 4. Router A 104a determines the metric values corresponding to the resources used to determine loading (step S400). These resources as well as the ensuing threshold values used to determine whether the device is overloaded can be the same or different from those used for new peer processing as set out is step S300 and/or step S304. If sufficient resources, are available within router A 104a to service the deferred peer and routes, the tag indicating that the peer is a deferred peer is removed, and router C 104c is treated as a normal peer with its routes being processed normally by router A 104a (step S404) in accordance with the general routing protocol. As such, for BGP, the route additions buffered by router A 104a in step S302 are processed normally and added to the BGP routing table for router A 104a and propagated in accordance with any other pre-established routing policy. Similarly, router A 104a can transmit to router C 104c routes available via autonomous system X 102A in accordance with any pre-defined routing policy.

If sufficient resources do not exist, (step S402), router A 104a separates the routes to be added and the routes to be deleted based on the routing update received from deferred peer router C 104c (step S408). The route deletions are processed and advertised as part of the typical peer routing update, for example, as part of the BGP routing update (step S408) and/or as part of an internal routing protocol update such as an Open Shortest Path First (“OSPF”) routing update, but the route additions received from router C 104c are merely buffered (step S410).

Of note, while it is unlikely that a routing update received from a brand new peer would include route deletions, it is contemplated that such could happen and/or a peer that has been previously deferred will remain deferred for a period of time and thus require processing as part of step S206 as shown in FIG. 2. In such a case, it is likely that router A 104a would receive a routing update from deferred peer router C 104c that includes route deletions. By processing only the route deletions and buffering the route additions, processing and resource utilization can be conserved while simultaneously decreasing the size of the routing table through the processing of the route deletions.

In addition, by processing route deletions and propagating those through the normal routing update to other routing peers, the “blackholing” of routes can be avoided. Put another way, if route deletions are not processed and propagated, it is likely that router A 104a will receive data packets destined for the autonomous system that other routers will believe is accessible via router A 104a by virtue of inclusion of the route in the BGP routing table. Receiving data packets from other routers within autonomous systems X 102A and other autonomous systems such as autonomous system Z 102C and attempting to pass those along to router C 104c even where router C 104c transmitted a route deletion update to router A 104a, will result in unnecessary buffering, processing, etc., by both router A 104a and router C 104c. As such, in order to avoid this undesired effect, route deletions are processed, but route additions are merely buffered. Once the route deletions have been processed and advertised and the route additions buffered, the peer, for example router C 104c is back pressured by router A 104a (step S412), and router C 104c is marked within router A 104a as being an unsynchronized peer (step S414).

An unsynchronized peer is still technically a deferred peer, the difference between deferral and unsynchronization being one of a temporal nature. A peer router 104 that has not ever been synchronized is a deferred peer. A peer router 104 that was previously synchronized that can not as some point in the future have a routing update processed due to resource limitations is an unsynchronized peer.

As an example of back-pressuring, a peer can be back pressured by not reading from the Transmission Control Protocol/Internet Protocol (TCP/IP) socket for that peer, i.e., do not send TCP acknowledgements. This will slow down the peer and will cause the deferred peer to close the TCP connection, thereby saving the overloaded peer from crashing. Of note, because the route additions are buffered but not processed, the router can determine how much space and resources it will need to actually process the full routing update. As such, a determination can be made at an appropriate time, whether through the synchronization or deferment processes, that sufficient resources are available to accommodate the routing update. Put another way, the thresholds set forth in step S304, step S402, step S402, and step S504 can be dynamically adjusted based on the actual resources required to process the routes received from a peer router 104.

Unsynchronized peer processing shown as step S210 in FIG. 2 is explained in detail with reference to FIG. 5. Initially, a methodology for servicing the unsynchronized peer routers is established (step S500). Such a methodology might include, for example, using a best fit mechanism based on expected resource and consumption and amount available within the router and/or be based on servicing the most heavily back-pressured peers first. One can determine the most heavily back pressured peer by, for example, counting the number of unacknowledged data packets or the amount of unacknowledged data.

The resource metric values for the peer are determined (step S502). The specific metric values as well as the threshold for determining whether sufficient resources are available can be the same or different from those used in step S300 and step S304 in FIG. 3, and steps S400-S402 in FIG. 4. Once the resource metric values have been determined, the ranking for servicing the unsynchronized peers can be determined. Of course, if the ranking is based purely on an algorithm such as the most heavily back-pressured peer (as opposed to determining best fit for available resources), the resource metric values need not be determined prior to establishing the therefore servicing unsynchronized peers.

With respect to the first unsynchronized peer, if sufficient resources are available to accommodate the routing data (step S504), normal route processing is performed (step S506) similar to that discussed above with respect to step S404 and the peer is marked as synchronized (step S508). If sufficient resources are not available (step S504), router A 104a continues to back-pressure the unsynchronized peer (step S510). If there are no additional unprocessed peers (step S512), the process ends. If there are additional unprocessed peers, the next peer in the processing order ranking is determined (step S514) and the process reverts back to determining current resource metric values in accordance with step S502.

The present invention, de-couples the processing of route additions and deletions thereby also effectively decoupling inbound routes received from a peer router in another autonomous system from outbound routes transmitted to other autonomous systems. This is the case because route deletions can be processed and transmitted to other autonomous systems, while route additions can be held until such time as the router has sufficient resources to be able to accommodate route processing and anticipated traffic flow based on the route additions. This arrangement advantageously adds significant stability to the routing platforms and environment by eliminating “blackholing” and router crashes.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

I claim:

1. An apparatus in a system for exchanging routing information with a peer router in another system, the apparatus and peer router being in data communication, the apparatus including:
a network interface for receiving and transmitting the routing information; and
a central processing unit in operative communication with the network interface, the central processing unit operating to:
determine a resource utilization level of the apparatus; and
establish a peering relationship with the peer router based on the resource utilization level.

2. The apparatus of claim 1, wherein the resource utilization level of the apparatus is based on one or more of a utilization rate of the central processing unit, an amount of remaining storage capacity and a bandwidth utilization of the network interface.

3. The apparatus of claim 1, wherein the routing information is Border Gateway Protocol routing information.

4. The apparatus of claim 1, wherein the apparatus further includes a storage device operatively coupled to the central processing unit and the network interface, wherein establishing a peering relationship with the peer router includes new peer processing, wherein the central processing unit operates to processes a new peer relationship by:
receiving a routing update received from the new peer;
buffering the routing update in the storage device;
determining whether sufficient resources exist to fully establish a peer relationship with the peer router;
marking the peer router as a deferred peer if it is determined that sufficient resources do not exist; and
marking received routes to be added from the deferred peer as unadvertised and holding the unadvertised routes in the storage device.

5. The apparatus of claim 1, wherein establishing a peering relationship with the peer router includes deferred peer processing, the apparatus further including a storage device operatively coupled to the central processing unit and the network interface, the storage device storing a routing update received from a deferred peer, the routing update including at least one of a route to be added and a route to be deleted, wherein the central processing unit operates to processes a deferred peer by:
determining whether sufficient resources exist to fully establish a peer relationship with the deferred peer router;
if sufficient resources do not exist to fully establish a peer relationship with the deferred peer router:
separating routes to be added from routes to be deleted;
processing and advertising the routes to be deleted;
buffering the routes to be added in the storage device;
back-pressuring the deferred peer router; and
marking the deferred peer router as an unsynchronized peer router.

6. The apparatus of claim 1, wherein establishing a peering relationship with the peer router includes unsynchronized peer processing, wherein the central processing unit operates to processes an unsynchronized peer by:
determining whether sufficient resources exist to fully establish a peer relationship with the unsynchronized peer router; and
back-pressuring the unsynchronized peer router if sufficient resources do not exist to fully establish a peer relationship.

7. The apparatus of claim 6, wherein the central processing unit operates to process the unsynchronized peer in accordance with a predetermined servicing methodology.

8. The apparatus of claim 7, wherein the predetermined servicing methodology is based on at least one of a most back-pressured peer and a best fit for available resources.

9. A method for an apparatus in a routing system to exchange routing information with a peer router in another system, the method including:
determining a resource utilization level of the apparatus; and
establish a peering relationship with the peer router based on the resource utilization level.

10. The method of claim 9, wherein the resource utilization level of the apparatus is based on one or more of a utilization rate of the central processing unit in the apparatus, an amount of remaining storage capacity of the apparatus and a bandwidth utilization of a network interface of the apparatus.

11. The method of claim 9, wherein the routing information is Border Gateway Protocol routing information.

12. The method of claim 9, wherein establishing a peering relationship with the peer router includes new peer processing, wherein new peer processing includes:
receiving a routing update received from the new peer;
buffering the routing update;
determining whether sufficient resources exist to fully establish a peer relationship with the peer router;
marking the peer router as a deferred peer if it is determined that sufficient resources do not exist; and
marking received routes to be added from the deferred peer as unadvertised and holding the unadvertised routes.

13. The method of claim 9, wherein establishing a peering relationship with the peer router includes deferred peer processing, wherein deferred peer processing includes:
determining whether sufficient resources exist to fully establish a peer relationship with the deferred peer router;
if sufficient resources do not exist to fully establish a peer relationship with the deferred peer router:
separating routes to be added from routes to be deleted;
processing and advertising the routes to be deleted;
buffering the routes to be added;
back-pressuring the deferred peer router; and
marking the deferred peer router as an unsynchronized peer router.

14. The method of claim 9, wherein establishing a peering relationship with the peer router includes unsynchronized peer processing, unsynchronized peer processing includes:
determining whether sufficient resources exist to fully establish a peer relationship with the unsynchronized peer router; and
back-pressuring the unsynchronized peer router if sufficient resources do not exist to fully establish a peer relationship.

15. The method of claim 14, wherein the unsynchronized peer router is serviced in accordance with a predetermined servicing methodology.

16. The method of claim 15, wherein the predetermined servicing methodology is based on at least one of a most back-pressured peer and a best fit for available resources.

17. A storage medium storing a computer program which when executed by a processing unit performs a method for an apparatus in a routing system to exchange routing information with a peer router in another system, the method comprising:
determining a resource utilization level of the apparatus; and
establish a peering relationship with the peer router based on the resource utilization level.

18. The storage medium of claim 17, wherein the resource utilization level of the apparatus is based on one or more of a utilization rate of the central processing unit in the apparatus, an amount of remaining storage capacity of the apparatus and a bandwidth utilization of a network interface of the apparatus.

19. The storage medium of claim 17, wherein the routing information is Border Gateway Protocol routing information.

20. The storage medium of claim 17, wherein establishing a peering relationship with the peer router includes new peer processing, wherein new peer processing includes:
receiving a routing update received from the new peer;
buffering the routing update;
determining whether sufficient resources exist to fully establish a peer relationship with the peer router;
marking the peer router as a deferred peer if it is determined that sufficient resources do not exist; and
marking received routes to be added from the deferred peer as unadvertised and holding the unadvertised routes.

21. The storage medium of claim 17, wherein establishing a peering relationship with the peer router includes deferred peer processing, wherein deferred peer processing includes:
determining whether sufficient resources exist to fully establish a peer relationship with the deferred peer router;
if sufficient resources do not exist to fully establish a peer relationship with the deferred peer router:
separating routes to be added from routes to be deleted;
processing and advertising the routes to be deleted;
buffering the routes to be added;
back-pressuring the deferred peer router; and
marking the deferred peer router as an unsynchronized peer router.

22. The storage medium of claim 17, wherein establishing a peering relationship with the peer router includes unsynchronized peer processing, unsynchronized peer processing includes:
determining whether sufficient resources exist to fully establish a peer relationship with the unsynchronized peer router; and
back-pressuring the unsynchronized peer router if sufficient resources do not exist to fully establish a peer relationship.

23. The storage medium of claim 22, wherein the unsynchronized peer router is serviced in accordance with a predetermined servicing methodology.

24. The storage medium of claim 23, wherein the predetermined servicing methodology is based on at least one of a most back-pressured peer and a best fit for available resources.
